(19) United States
(12) Patent Application Publication
(10) Pub. No.: US 2023/0092824 A1
(43) Pub. Date: Mar. 23, 2023

(54) CHECKOUT DEVICE AND CONTROL METHOD THEREOF

(71) Applicant: TOSHIBA TEC KABUSHIKI KAISHA, Tokyo (JP)

(72) Inventors: Yuji HAYASHI, Tagata Shizuoka (JP); Eisuke AOYAMA, Yao Osaka (JP)

(21) Appl. No.: 17/873,056

(22) Filed: Jul. 25, 2022

(30) Foreign Application Priority Data
Sep. 22, 2021 (JP) 2021-154094

(51) Int. Cl. G07G 1/00; G07G 1/01; G06Q 20/20

(52) U.S. Cl. CPC G07G 1/0072; G07G 1/01; G06Q 20/208

(57) ABSTRACT

A checkout device in a point of sales (POS) system includes a table on which one or more merchandise items can be placed, a scale configured to measure a total weight of the merchandise items placed on the table, a scanner configured to read an image displayed on a terminal operated by a customer, and a processor. The processor is configured to, upon receipt of the image by the scanner, determine one or more merchandise items that have been registered by the customer using the terminal, determine a total weight of the registered merchandise items using a weight predetermined for each merchandise item, determine whether a difference between the determined total weight and the measured total weight exceeds a threshold, and upon determining that the difference exceeds the threshold, issue an abnormal command.

### CROSS-REFERENCE TO RELATED APPLICATION

This application is based upon and claims the benefit of priority from Japanese Patent Application No. 2021-154094, filed Sep. 22, 2021, the entire contents of which are incorporated herein by reference.

### FIELD

Embodiments described herein relate to a checkout device, a method performed by a checkout device, and a point of sales (POS) system.

### BACKGROUND

A sales transaction processing system that allows a customer to register merchandise items inside a store using his or her smartphone and pay for them using a checkout device installed in the store is known. By introducing this type of sales transaction processing system into a retail store such as a supermarket, the need for registering merchandise items at checkout is eliminated, and thus the time required for checkout can be shortened.

On the other hand, in such a sales transaction processing system, since the customer operates the checkout device by himself or herself, when the data related to a purchased merchandise item is not input correctly either by the customer's fraudulent activity or due to the customer's operation error, the transaction processing may still be completed normally though with incorrect merchandise data. Therefore, there is a need to avoid a situation in which a customer leaves a store with unregistered merchandise, whether such result is intentional or unintentional.

### BRIEF DESCRIPTION OF THE DRAWINGS

FIG. 1 is a schematic block diagram of a transaction processing system.

FIG. 2 is a sequence diagram explaining main functions performed by a shopping support terminal and a virtual POS server.

FIG. 3 is a diagram of a payment machine.

FIG. 4 is a hardware block diagram of a payment machine.

FIGS. 5 through 7 are flow charts of information processing executed by a payment machine.

FIG. 8 is a schematic diagram illustrating an example of a guidance screen.

FIG. 9 is a schematic diagram illustrating an example of a selection screen.

FIG. 10 is a schematic diagram illustrating an example of a calling screen.

FIG. 11 is a schematic diagram illustrating an example of a transaction screen.

### DETAILED DESCRIPTION

A checkout device and a method performed by a checkout device are provided, which are capable of preventing a customer from leaving a store with an unregistered merchandise item.

In general, according to one embodiment, a checkout device in a POS system includes a table on which one or more merchandise items can be placed, a scale configured to measure a total weight of the merchandise items placed on the table, a scanner configured to read an image displayed on a terminal operated by a customer, and a processor. The processor is configured to, upon receipt of the image by the scanner, determine one or more merchandise items that have been registered by the customer using the terminal, determine a total weight of the registered merchandise items using a weight predetermined for each merchandise item, determine whether a difference between the determined total weight and the measured total weight exceeds a threshold, and upon determining that the difference exceeds the threshold, issue an abnormal command.

Hereinafter, certain example embodiments will be described with reference to the drawings. In the example embodiments, a sales transaction processing system in which a customer operates a terminal to register merchandise items displayed and sold in a store and then operates a dedicated checkout device to perform checkout processing as necessary to pay for the merchandise items.

Description of Configuration of Transaction Processing System

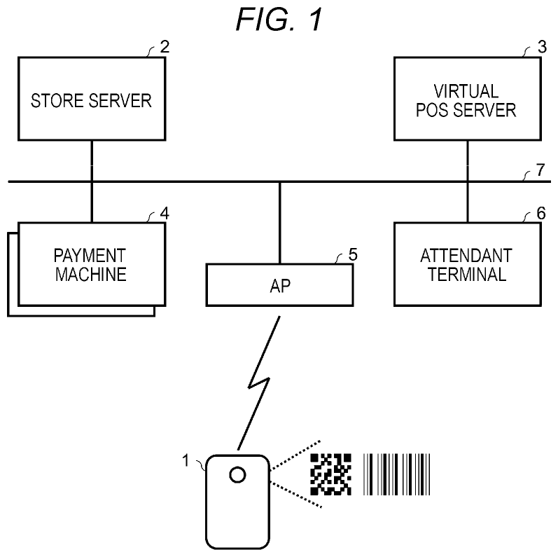

FIG. 1 is a schematic block diagram of a sales transaction processing system S. The transaction processing system S includes a shopping support terminal 1, a store server 2, a virtual POS server 3, a payment machine 4, an access point 5, and an attendant terminal 6. The store server 2, the virtual POS server 3, the payment machine 4, the access point 5, and the attendant terminal 6 are interconnected to each other by a communication network 7. The communication network 7 is typically a wired or wireless local area network (LAN).

The shopping support terminal 1 is used by a customer to input data related to a purchased merchandise item by himself or herself. The shopping support terminal 1 is a portable terminal including an input device, a display device, a wireless unit, and also an image capturing device necessary for reading a code symbol such as a two-dimensional code, a barcode, or the like. For example, a commercially available smartphone, a tablet terminal, or the like including a digital camera can be used as the shopping support terminal 1.

The store server 2 supports overall store operations. To support this, the store server 2 stores various databases including a merchandise database (also referred to in some contexts as a merchandise master database). The merchandise database is a collection of merchandise records for each merchandise item sold in a store. For example, the merchandise record includes merchandise data including a merchandise code, a merchandise name, a price, a weight, and the like. The merchandise code is a unique identification code set for each merchandise item in order to individually identify the merchandise item. Each merchandise item usually has a barcode attached or associated therewith indicating the merchandise code. The weight is a preset (expected) weight for each unit of merchandise.

The virtual POS server 3 cooperates with the shopping support terminal 1 to perform the functions corresponding to a conventional POS terminal. For example, the virtual POS server 3 has the following three functions. The first function is a function of registering, in a transaction file, merchandise sales data of a merchandise item that is identified by a merchandise code input via the shopping support terminal 1. The merchandise sales data and the transaction file will be described later. The second function is a function of displaying, on a display device of the shopping support terminal 1, a registration screen that is generated based on the merchandise sales data registered in the transaction file. The third function is a function of displaying a payment barcode on the display device of the shopping support terminal 1 in response to a payment instruction from the shopping support terminal 1. The payment barcode will be described later.

The payment machine 4 is a checkout device that enables a customer who has input data related to a purchased merchandise item using the shopping support terminal 1, to perform payment processing necessary to pay for the purchased merchandise item by himself or herself. A plurality of payment machines 4 can be connected to the communication network 7. Methods of payment processing are not particularly limited. A known checkout method by cash, credit card, electronic money, point, barcode (also referred to as mobile checkout or smartphone checkout), and the like can be used.

The access point 5 is a communication device installed in the store as a relay device when each server (i.e., the store server 2, virtual POS server 3, and the like) of the transaction processing system S performs data communication with the shopping support terminal 1 via a wireless LAN. For example, the wireless LAN conforms to the Wi-Fi® standard. Although FIG. 1 illustrates only one access point 5 in the transaction processing system S, the number of access points 5 is not limited. A plurality of access points 5 may be connected to the communication network 7 according to the scale of the store and the like.

The attendant terminal 6 is used by a store clerk or attendant who monitors the status of the shopping support terminal 1 and the payment machine 4.

Note that the configuration of the transaction processing system S is not limited to that illustrated in FIG. 1. For example, the functions of the store server 2 and virtual POS server 3 may be implemented in one server so as to reduce the total number of servers. Further, separate from the payment machine 4, there may be a conventional POS terminal that allows a store clerk to perform registration operations and checkout operations on purchased merchandise items, or there may be a semi-self-service registration machine and a payment machine so that the clerk can perform the registration operation using the registration machine and the customer can perform the checkout operation using the payment machine by himself or herself, which may be connected to the communication network 7.

Description of Functions of Shopping Support Terminal and Virtual Pos Server

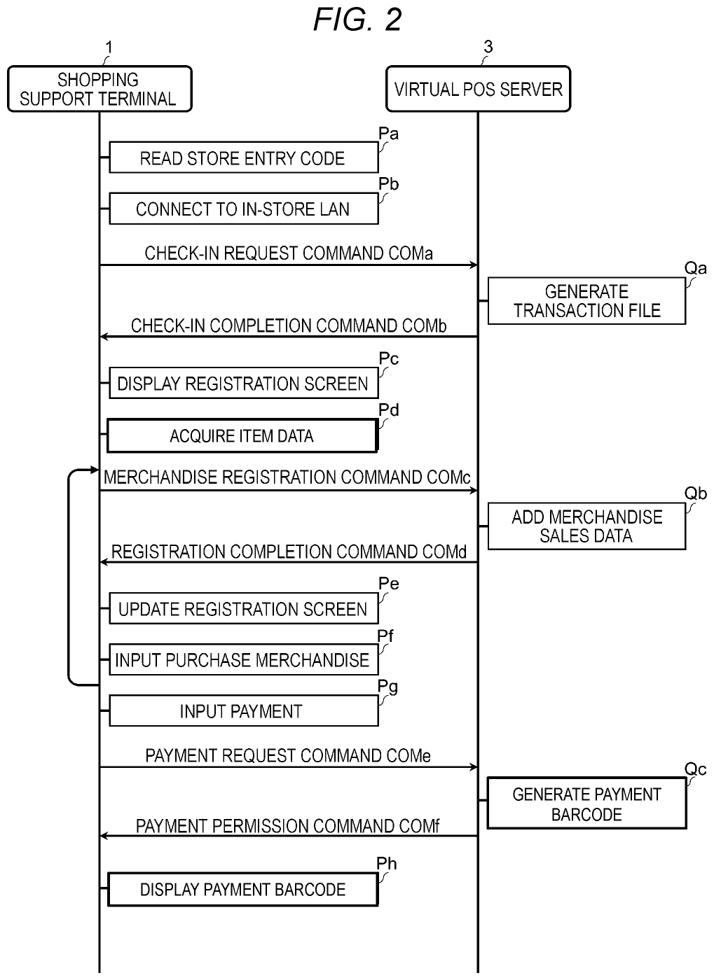

Next, the main functions of the shopping support terminal 1 and the virtual POS server 3 will be described with reference to the sequence diagram of FIG. 2.

First, a customer who wants to use a smartphone as the shopping support terminal 1 installs on the smartphone a shopping support application program for in-store use, or so-called a shopping application (or “app”), which is developed for the transaction processing system S. The customer can use the smartphone as the shopping support terminal 1 through user registration via the shopping application or the like.

The customer carrying the shopping support terminal 1 activates the shopping application before entering a store. Then, as illustrated by function Pa, a camera of the shopping support terminal 1 is activated to read a store entry code. The store entry code encodes setting information for the store into a two-dimensional code that is displayed at the entrance of the store, for example. For example, the setting information includes parameters necessary for the shopping support terminal 1 to communicate with the access point 5 using a wireless LAN, information related to operation restrictions of the shopping support terminal 1, and the like. The customer operates the shopping support terminal 1 to scan the store entry code with the camera thereof.

After the store entry code is read by the shopping support terminal 1, the shopping support terminal 1 can be connected to the access point 5 using the wireless LAN, as illustrated by function Pb. Then, when the shopping support terminal 1 is connected to the access point 5, the shopping support terminal 1 transmits a check-in request command COMa to the virtual POS server 3. The check-in request command COMa is transmitted from the access point 5 to the virtual POS server 3 via the communication network 7. The check-in request command COMa includes terminal identification (ID) information of the shopping support terminal 1. The terminal ID information is unique information that differs from those of the shopping support terminals 1 used by other customers. For example, a unique program ID (e.g., serial number) of the shopping application installed on the shopping support terminal 1 is used as the terminal ID information.

The virtual POS server 3 that has received the check-in request command COMa generates a transaction file, as illustrated by function Qa. The transaction file is a data file for registering merchandise sales data of a merchandise item identified by a merchandise code input via the shopping support terminal 1. The transaction file is generated for each shopping support terminal 1. The terminal ID information of the shopping support terminal 1 is associated with each transaction file.

The virtual POS server 3 that has generated the transaction file transmits a check-in completion command COMb to the shopping support terminal 1 that is a transmission source of the check-in request command COMa. The check-in completion command COMb is transmitted from the access point 5 to the shopping support terminal 1 via the communication network 7.

The shopping support terminal 1 that has received the check-in completion command COMb displays a registration screen, as illustrated by function Pc. The registration screen displays the merchandise name, price, and the like of the merchandise item identified by the merchandise code input via the shopping support terminal 1. A merchandise registration button is displayed on the registration screen.

The customer places the shopping support terminal 1 on a shopping cart or carries it and moves around the sales floor where merchandise items are displayed. Then, when finding a merchandise item to be purchased, the customer operates the merchandise registration button displayed on the shopping support terminal 1. When the merchandise registration button is operated, the shopping support terminal 1 acquires the data of the purchased merchandise item, as illustrated by function Pd. For example, the shopping support terminal 1 is in a standby state for reading a barcode. The customer operates the shopping support terminal 1 to read the barcode attached to the purchased merchandise item with the camera. When the barcode of the merchandise item is read by the camera, the shopping support terminal 1 acquires the merchandise code represented by the barcode as the data of the purchase merchandise item.

A “No Barcode” button is also displayed on the registration screen. When the purchased merchandise item does not have a barcode, the customer operates the “No Barcode” button. When the “No Barcode” button is operated, the display device displays a list of merchandise items without barcode. The customer selects a purchased merchandise item from the list. When the purchase merchandise is selected, the shopping support terminal 1 acquires the merchandise code of the selected merchandise item as the data of the purchase merchandise item.

When the data of the purchase merchandise item is acquired, the shopping support terminal 1 transmits a merchandise registration command COMc to the virtual POS server 3. The merchandise registration command COMc is transmitted from the access point 5 to the virtual POS server 3 via the communication network 7. The merchandise registration command COMc includes the terminal ID information of the shopping support terminal 1 and the data of the purchase merchandise item.

The virtual POS server 3 that has received the merchandise registration command COMc adds merchandise sales data to the transaction file associated with the terminal ID information of the shopping support terminal 1 that is the transmission source of the merchandise registration command COMc, as illustrated by function Qb. The merchandise sales data includes the merchandise code, merchandise name, unit price, quantity, sales amount, weight, and the like of the purchased merchandise item. The sales amount is obtained by multiplying the unit price by the quantity.

The virtual POS server 3 that had added the merchandise sales data to the transaction file transmits a registration completion command COMd to the shopping support terminal 1 that is the transmission source of the merchandise registration command COMc. The registration completion command COMd is transmitted from the access point 5 to the shopping support terminal 1 via the communication network 7.

The shopping support terminal 1 that has received the registration completion command COMd updates the registration screen, as illustrated by function Pe. That is, the shopping support terminal 1 updates the registration screen such that the merchandise name, price, and the like of the merchandise sales data added to the transaction file are displayed. On the updated registration screen, a payment button is also displayed along with the merchandise registration button and the like. The shopping support terminal 1 with the updated registration screen waits for data of another purchased merchandise item to be input as illustrated by function Pf, or for the payment button to be operated as illustrated by function Pg.

When the customer finds another merchandise item to be purchased, he or she operates the merchandise registration button. When the merchandise registration button is operated, the shopping support terminal 1 acquires the data of the purchase merchandise item. Then, the shopping support terminal 1 transmits the merchandise registration command COMc to the virtual POS server 3. Subsequent steps performed by the shopping support terminal 1 and the virtual POS server 3 are the same as described above.

Upon finishing shopping in the store, the customer operates the payment button displayed on the updated registration screen. When the payment button is operated, the shopping support terminal 1 transmits a payment request command COMe to the virtual POS server 3. The payment request command COMe is transmitted from the access point 5 to the virtual POS server 3 via the communication network 7. The payment request command COMe includes the terminal ID information of the shopping support terminal 1.

After that, the virtual POS server 3 generates a unique payment barcode, as illustrated by function Qc. For example, the virtual POS server 3 generates a payment barcode by encoding the terminal ID information of the shopping support terminal 1 that is the transmission source of the payment request command COMe. Upon generating the payment barcode, the virtual POS server 3 transmits a payment permission command COMf to the shopping support terminal 1 that is the transmission source of the payment request command COMe. The payment permission command COMf is transmitted from the access point 5 to the shopping support terminal 1 via the communication network 7. The payment permission command COMf includes payment barcode data.

The shopping support terminal 1 that has received the payment permission command COMf displays on the display device an image of the payment barcode, as illustrated by function Ph. This payment barcode is used for checkout at the payment machine 4.

Description of Configuration of Payment Machine

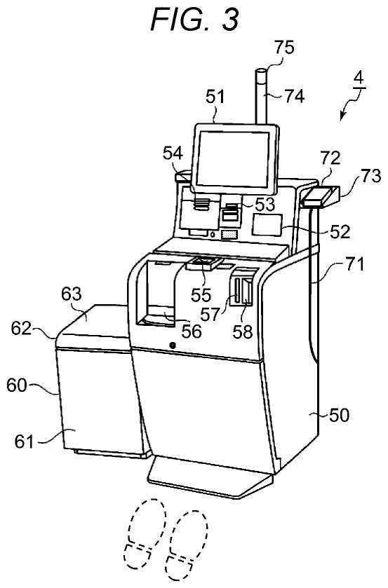

FIG. 3 is a diagram of the payment machine 4. The payment machine 4 includes a main body 50 installed on the floor surface and a scale unit 60 installed next to the main body 50. The main body 50 includes a touch panel 51 attached to an upper portion thereof.

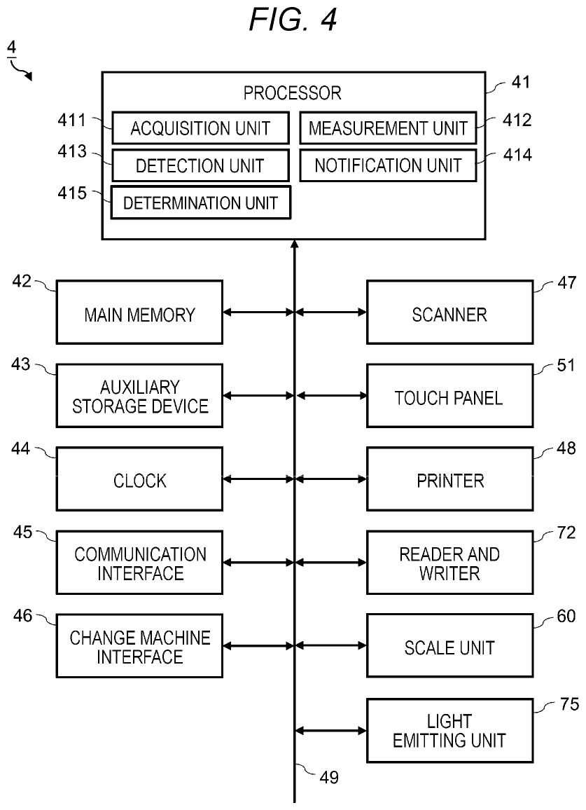

The main body 50 includes, on a front thereof, a reading window 52 of a scanner 47 (see FIG. 4), a card insertion slot 53, a receipt dispensing slot 54, a coin insertion slot 55, a coin dispensing slot 56, a bill insertion slot 57, and a bill dispensing slot 58. Further, a communication cable 71 extends from the right side of the main body 50 to the outside, and a reader and writer 72 for an electronic money medium is connected to a leading end of the communication cable 71. The reader and writer 72 is placed on a holder 73 provided on an upper right side of the main body 50.

The scale unit 60 has a structure in which a scale plate 62 is provided on an upper portion of a housing 61. The scale plate 62 has an upper surface as a placement surface 63. The scale unit 60 measures a total weight of what is placed on the placement surface 63. The scale unit 60 measures the weight of the purchased merchandise items and a shopping basket and the like for storing the purchased merchandise items. The scale unit 60 performs the function of a measurement unit 412 described below. In FIG. 3, the scale unit 60 is installed on a left side of the main body 50, although the position of installation is not limited thereto. The scale unit 60 may be installed on a right side of the main body 50.

FIG. 4 is a hardware block diagram of the payment machine 4. The payment machine 4 includes a processor 41, a main memory 42, an auxiliary storage device 43, a clock 44, a communication interface 45, a change machine interface 46, the scanner 47, the touch panel 51, a printer 48, the reader and writer 72, the scale unit 60, a light emitting unit 75, a system transmission line 49, and the like. The system transmission line 49 includes an address bus, a data bus, a control signal line, and the like. The system transmission line 49 connects the processor 41 and other parts directly or via a signal input and output circuit, and transmits data signals transmitted and received therebetween.

In the payment machine 4, the processor 41, the main memory 42, the auxiliary storage device 43, the clock 44, and the communication interface 45 are connected via the system transmission line 49. Those components are connected to a device interface or a device such as the change machine interface 46, the scanner 47, the touch panel 51, the printer 48, the reader and writer 72, the scale unit 60, the light emitting unit 75, and the like via the system transmission line 49.

The processor 41 controls each component of the payment machine 4 to perform various functions thereof according to an operating system or application programs. The processor 41 is a central processing unit (CPU), for example.

The main memory 42 includes a non-volatile memory area and a volatile memory area. The main memory 42 stores the operating system and/or the application programs in the non-volatile memory area. The main memory 42 may store data necessary for the processor 41 to execute a process for controlling each part in the non-volatile or volatile memory area. The volatile memory area of the main memory 42 is used as a work area in which data is temporarily stored by the processor 41. The non-volatile memory area is a read only memory (ROM), for example. The volatile memory area is random access memory (RAM), for example.

For example, the auxiliary storage device 43 is an Electric Erasable Programmable Read-Only Memory (EEPROM) (registered trademark), a Hard Disk Drive (HDD), a Solid State Drive (SSD), and the like. The auxiliary storage device 43 stores data used by the processor 41 to perform various processes, data generated by the processes of the processor 41, and the like. In some cases, the auxiliary storage device 43 may store the application programs described above.

The clock 44 keeps date and time. The processor 41 acquires the current date and time kept by the clock 44.

The communication interface 45 is a communication interface circuit that performs data communication with the store server 2, the virtual POS server 3, the payment machine 4, the access point 5, the attendant terminal 6, and the like connected via the communication network 7.

The change machine interface 46 is an interface circuit to communicate with an automatic change machine (not shown). The change machine interface 46 receives from the automatic change machine data of the amount of bills and coins inserted into the automatic change machine. The change machine interface 46 transmits data of change to the automatic change machine. The automatic change machine that has received the change data automatically dispenses the change based on the change data.

The scanner 47 is a reading device that reads code symbols such as barcodes, two-dimensional codes, and the like. The scanner 47 may be a type that reads a code symbol by scanning a laser beam, or a type that reads a code symbol from an image captured by an image capturing device.

The touch panel 51 is a device having both an input device and a display device. The touch panel 51 displays information to a customer who is an operator of the payment machine 4, and receives operation input by the customer.

The printer 48 prints various character strings, images, and the like on a receipt paper to issue a receipt. For the printer 48 of this type, a thermal printer, a dot impact printer, and the like can be used, for example.

The reader and writer 72 has a function of reading data recorded on a medium such as a card, a smartphone, and the like, and a function of writing data onto the medium. The card may include a point card and the like in addition to a payment card such as a credit card, a debit card, an electronic money card, a prepaid card, and the like. The reader and writer 72 may be a magnetic, contact type, or non-contact type device, and may include a plurality of types of devices.

In the payment machine 4 having such a configuration, the processor 41 performs the functions of an acquisition unit 411, the measurement unit 412, a detection unit 413, a notification unit 414, and a determination unit 415.

The acquisition unit 411 has two functions. The first function is to acquire an expected weight of a purchased merchandise item registered by using the information terminal operated by a customer. The second function is to acquire data related to the sale of the purchased merchandise item, including the expected weight (“set weight”) of the purchased merchandise item.

The measurement unit 412 has a function of measuring the total weight of the purchased merchandise items.

The detection unit 413 has a function of detecting an abnormality if a difference between the total of the expected weights acquired by the acquisition unit 411 and the total weight measured by the measurement unit 412 exceeds a threshold value.

The notification unit 414 has a function of notifying the terminal used by a store clerk of an occurrence of an abnormal event if an abnormality is detected by the detection unit 413.

The determination unit 415 has a function of determining whether to cancel the data related to the sale of the purchased merchandise item acquired by the acquisition unit 411 or to register the data related to the sale of a new merchandise item, if an abnormality is detected by the detection unit 413.

The functions of the acquisition unit 411, the measurement unit 412, the detection unit 413, the notification unit 414, and the determination unit 415 are all performed in information processing executed by the processor 41 according to a checkout program. The checkout program is a type of application program that is stored in the main memory 42 or the auxiliary storage device 43. The method of installing the checkout program in the main memory 42 or the auxiliary storage device 43 is not particularly limited. The checkout program may be recorded on a non-transitory computer readable recording medium, such as a CD-ROM, a memory card, and the like, or the checkout program may be distributed by communication via the communication network 7 so as to be installed in the main memory 42 or the auxiliary storage device 43. The recording medium may have any form as long as it can store a program and be read by a computer.

Description of Operation of Payment Machine

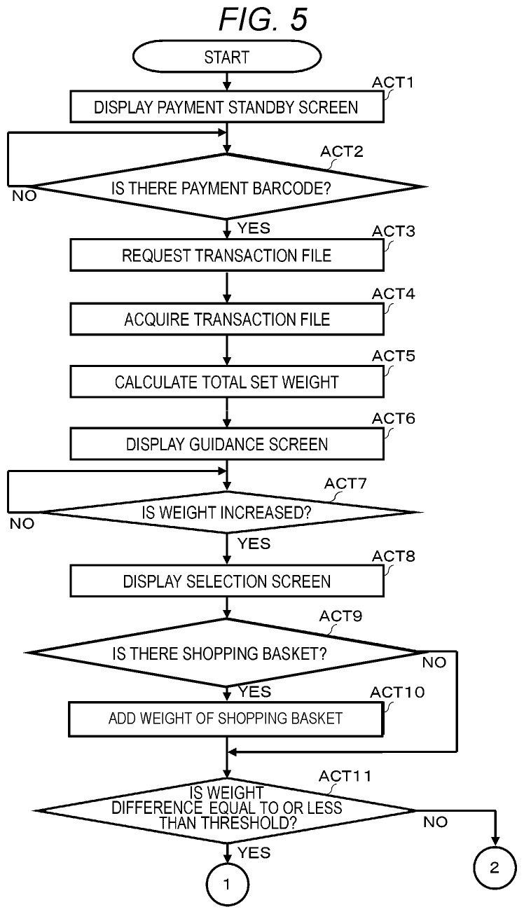

FIGS. 5 to 7 are flow charts of information processing executed by the processor 41 according to the checkout program. Hereinafter, the main operation of the payment machine 4 will be described with reference to each drawing. Note that the operations described below are examples. As long as the same effect can be achieved, the steps to be performed or the order thereof can be changed as appropriate.

The processor 41 controls the touch panel 51 to display a payment standby screen at ACTT in FIG. 5. The payment standby screen displays guidance for a customer who has completed the registration operation of purchased merchandise items by using the shopping support terminal 1, for example, to operate the scanner 47 to read the payment barcode displayed on the display device of the shopping support terminal 1. The processor 41 waits for the payment barcode to be read by the scanner 47, at ACT2.

After finishing shopping in the store, by operating the payment button, the customer can confirm that the payment barcode is displayed on the display device of the shopping support terminal 1, and then moves to the checkout area where the payment machine 4 is installed. Then, the payment barcode is read by the scanner 47 of the payment machine 4 on which the payment standby screen is displayed.

After the payment barcode is read by the scanner 47, the processor 41 determines YES in ACT2 and proceeds to ACT3. The processor 41 requests a transaction file from the virtual POS server 3, at ACT 3. As described above, the payment barcode is obtained by encoding the terminal ID information of the shopping support terminal 1. The terminal ID information of the shopping support terminal 1 is also associated with the transaction file stored in the virtual POS server 3. Therefore, the processor 41 requests a transaction file associated with the terminal ID information obtained from the payment barcode. After receiving this request, the virtual POS server 3 transmits the transaction file associated with the terminal ID information to the payment machine 4.

The processor 41 acquires the transaction file from the virtual POS server 3 by the function of the acquisition unit 411, at ACT 4.

At ACT5, the processor 41 calculates the total of the expected weights of the merchandise items registered in the transaction file. The processor 41 stores the total of the expected weights in the expected weight memory. The expected weight memory is formed in the volatile memory area of the main memory 42.

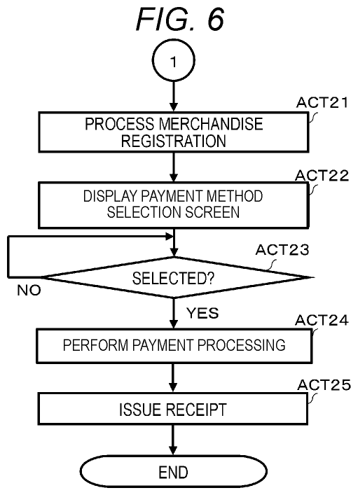

The processor 41 controls the touch panel 51 to display a guidance screen 100 (see FIG. 8) at ACT 6.

FIG. 8 is a schematic diagram illustrating an example of the guidance screen 100. As illustrated in FIG. 8, the guidance screen 100 displays a message for guiding a customer to place purchased merchandise items on the placement surface 63, along with a guidance image 101 showing the placement surface 63. Note that the text and image of the text data illustrated in FIG. 8 are mere examples.

The description will continue by referring back to FIG.

5.

The customer who has confirmed the guidance screen 100 places the purchased merchandise items on the placement surface 63. The processor 41 checks whether the total weight output by the scale unit 60 increases at ACT 7. If the total weight output by the scale unit 60 increases, the processor 41 determines YES at ACTT and proceeds to ACT8. If the total weight output by the scale unit 60 increases, it means that the customer placed the purchased merchandise items on the placement surface 63.

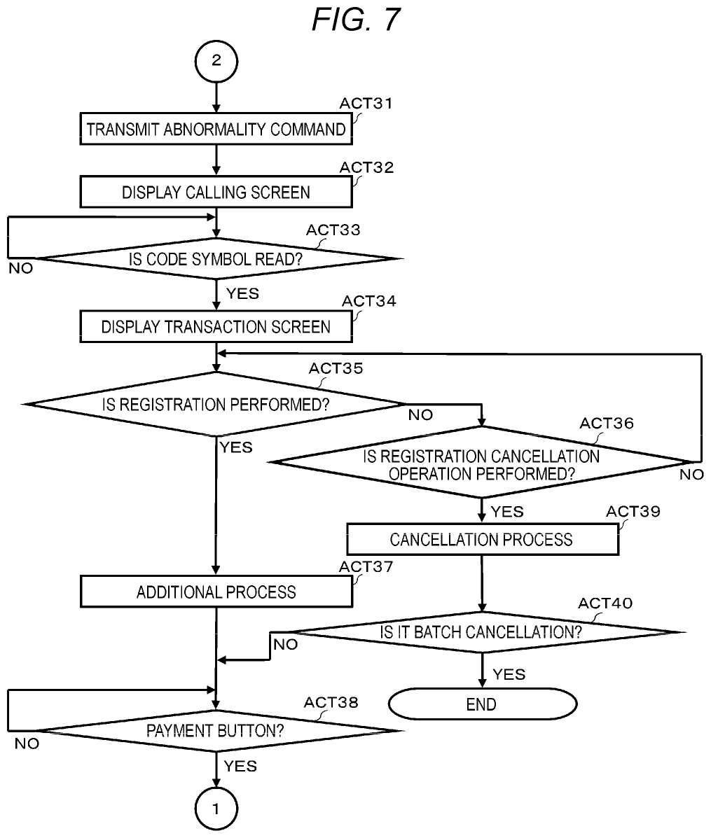

The processor 41 controls the touch panel 51 to display a selection screen 200 (see FIG. 9) at ACT 8.

FIG. 9 is a schematic diagram illustrating an example of the selection screen 200. As illustrated in FIG. 9, the selection screen 200 shows a message inquiring as to whether the customer is with or without a shopping basket, an image of a “With Shopping Basket” button 201 and an image of a “Without Shopping Basket” button 202. For example, regarding the case of “without shopping basket,” the customer directly places the purchased merchandise items on the placement surface 63, or the customer places his or her own bag storing the purchased merchandise items on the placement surface 63. Note that the text and image of the text data illustrated in FIG. 9 are mere examples.

The description will continue by referring back to FIG. 5.

The processor 41 checks whether the “With Shopping Basket” button 201 is touched, at ACT9. If the “With Shopping Basket” button 201 is touched, the processor 41 determines YES at ACT9 and proceeds to ACT10.

At ACT 10, the processor 41 adds the weight of the shopping basket to the total of the expected weights stored in the expected weight memory. The weight obtained by adding the weight of the shopping basket to the total of the expected weights is referred to as the “weight after addition.” The weight of the shopping basket is stored in a shopping basket memory. The shopping basket memory is formed in the volatile memory area of the main memory 42. It is assumed that the weight of the shopping basket is a preset value provided by the store. For example, the weight of the shopping basket may be a fixed value or a different value for each store. The weight used for the shopping basket may be a value obtained by adding a slight margin to the average weight of the shopping baskets used in the store, for example.

If the “Without Shopping Basket” button 202 is touched, the processor 41 determines NO in ACT9, skips the process of ACT10, and proceeds to ACT11.

If the process at ACT 10 is executed, the processor 41 checks whether a difference between the weight after addition and the total weight output by the scale unit 60 is equal to or less than a threshold value, at ACT 11. If the process at ACT 10 is skipped, the processor 41 checks whether the difference between the total of the expected weights stored in the expected weight memory and the total weight output by the scale unit 60 is equal to or less than the threshold value. The threshold value is stored in a threshold value memory. The threshold valve memory is formed in the volatile memory area of the main memory 42. At this time, if the difference between the weight after addition or the total of the expected weights and the total weight output by the scale unit 60 is equal to or less than the threshold value, the processor 41 determines that the weight after addition or the total of the expected weights and the total weight output by the scale unit 60 are the same. The reason that the weight after addition or the total of the expected weights and the total weight output by the scale unit 60 are determined to be the same as each other in view of the variations in the total weight output by the scale unit 60 due to vibrations applied to the scale unit 60, the weight of the shopping basket, the weight of the customer's own bag, and the like.

If the difference between the weight after addition or the total of the expected weights and the total weight output by the scale unit 60 is equal to or less than the threshold value, the processor 41 determines YES in ACT 11 and proceeds to ACT 21 in FIG. 6.

The processor 41 executes the merchandise registration process, at ACT 21. Specifically, the processor 41 registers the sales data of the purchased merchandise items in a sales aggregation memory based on the merchandise sales data registered in the transaction file. The sales aggregation memory is formed in the volatile memory area of the main memory 42. By this registration process, the total amount of the transaction is calculated.

The processor 41 controls the touch panel 51 to display a payment method selection screen. The payment method selection screen shows images of payment method selection buttons such as a cash button, a credit button, an electronic money button, and the like. If the cash button is touched, cash is selected as the payment method. If the credit button is touched, the credit card is selected as the payment method. If the electronic money button is touched, electronic money is selected as the payment method. Note that the payment method is not limited to these three types, that is, cash, credit card, and electronic money. Either two types may be used, or another payment method may be selectable. Further, only one payment method may be used. In such a case, instead of the payment method selection button, a payment start button for instructing to start the payment may preferably be displayed on the payment method selection screen, for example.

The processor 41 waits for the payment method to be selected, at ACT 23. Then, if any payment method is selected by an operation input to the payment method selection screen, the processor 41 determines YES at ACT 23 and proceeds to ACT 24.

The processor 41 executes the payment process, at ACT 24. For example, if cash is selected as the payment method, the processor 41 executes the process of deducting the total amount from the amount put into the automatic change machine, calculating and dispensing the change from the automatic change machine. For example, if the credit card is selected as the payment method, the processor 41 authenticates a credit card read by the reader and writer 72, and determines the total amount as the credit payment amount on condition that it is approved. For example, if the electronic money is selected as the payment method, the processor 41 withdraws the total amount from the balance of the electronic money medium read by the reader and writer 72.

The processor 41 controls the issuance of a receipt by the printer 48, at ACT 25. Transaction details data such as the merchandise name, purchase price, number of items, purchase amount, total number of items, total amount, payment amount, and the like of the purchased merchandise items are printed on the receipt. The number of items is the number of purchased merchandise items, and the purchase amount is obtained by multiplying the price by the number of items.

Upon controlling the issuance of the receipt, the processor 41 ends the information processing of the procedure illustrated in FIGS. 5 to 6.

The description will continue by referring back to FIG. 5.

If the difference between the weight after addition or the total of the expected weights and the total weight output by the scale unit 60 exceeds the threshold value, the processor 41 determines NO in ACT 11 and proceeds to ACT 31 in FIG. 7. That is, if the difference between the weight after addition or the total of the expected weights by the function of the detection unit 413 and the total weight output by the scale unit 60 exceeds the threshold value, the processor 41 detects an abnormality.

The processor 41 issues an abnormality command by the function of the notification unit 414 and controls the communication interface 45 to transmit the abnormality command to the attendant terminal 6, at ACT 31. By this control, the abnormality command is transmitted from the communication interface 45 to the attendant terminal 6 via the communication network 7. The abnormality command includes a payment machine ID. The payment machine ID is payment machine identification information set for identifying each payment machine 4.

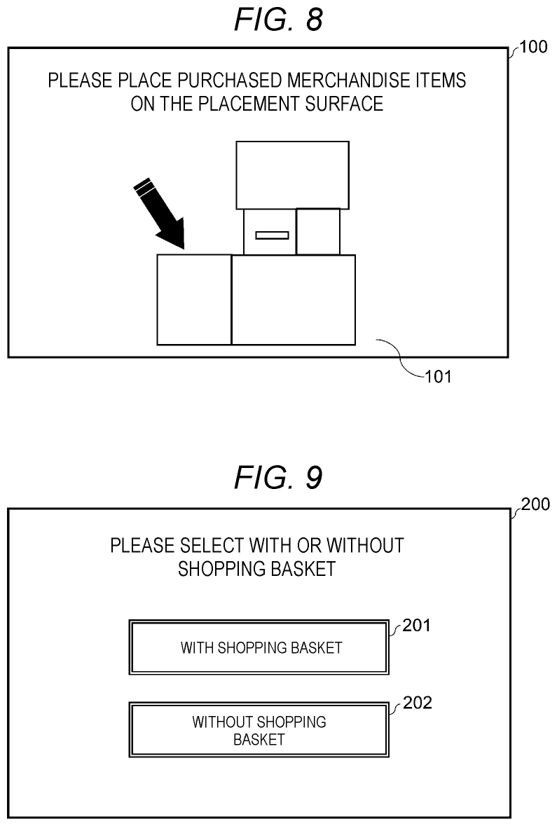

The processor 41 controls the touch panel 51 to display a calling screen 300 (see FIG. 10) at ACT 32.

FIG. 10 is a schematic diagram illustrating an example of the calling screen 300. As illustrated in FIG. 10, the calling screen 300 shows a message for notifying the customer that a weight abnormality is occurred and that an attendant is being called. Note that the text displayed in FIG. 10 is a mere example.

The attendant terminal 6 that has received the abnormality command displays an abnormality occurrence screen on the touch panel. The abnormality occurrence screen notifies the attendant that a weight abnormality is occurred in the payment machine 4 identified by the payment machine ID, for example.

The attendant who confirmed the abnormality occurrence screen rushes to the payment machine 4 where the weight abnormality is occurred. In order to operate the payment machine 4 in an attendant mode, the attendant operates the scanner 47 to read a code symbol such as a barcode, a two-dimensional code, and the like storing the attendant ID. The code symbol is printed on an ID card and the like possessed by each attendant, for example. That is, the processor 41 waits for the code symbol storing the attendant ID to be read by the scanner 47, at ACT 33 of FIG. 7.

If the code symbol storing the attendant ID is read by the scanner 47, the processor 41 determines YES at ACT 33 and proceeds to ACT 34.

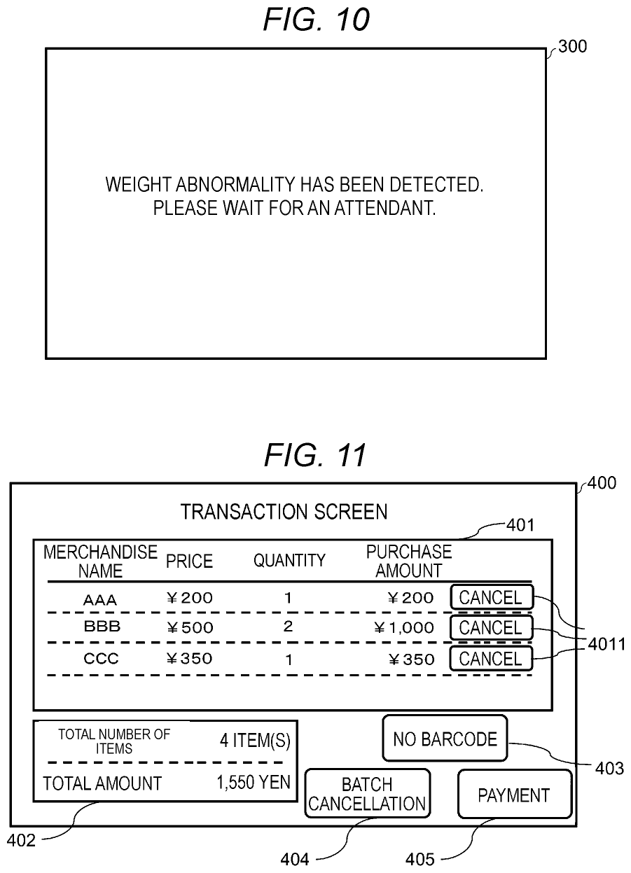

The processor 41 controls the touch panel 51 to display a transaction screen 400 (see FIG. 11) at ACT 34.

FIG. 11 is a schematic diagram illustrating an example of the transaction screen 400. As illustrated in FIG. 11, the transaction screen 400 shows a details section 401 displaying the merchandise sales data registered in the transaction file, a total section 402 for displaying a total number of items and a total amount of purchased merchandises items, an image of a “No Barcode” button 403, an image of a “Batch Cancellation Button” 404 for instructing batch cancellation, and an image of a “Payment” button 405 for instructing payment. The details section 401 includes the merchandise name of the purchased merchandise item, price, number of items, purchase amount, and an individual “Cancel” button 4011. If the “Cancel” button 4011 is touched, the registration of the purchased merchandise item corresponding to that button 4011 is canceled. If the “No Barcode” button 403 is touched, a list of no barcode merchandise items is displayed on the touch panel 51. The attendant selects one or more purchased merchandise items from the list. If the “Batch Cancellation” button 404 is touched, the registration of all purchased merchandise items displayed in the details section 401 is canceled. If the “Payment” button 405 is touched, the merchandise registration process is executed. Note that the text and image illustrated in FIG. 11 are mere examples.

In such a case, the attendant reviews the merchandise sales data displayed in the details section 401 and the purchased merchandise items placed on the placement surface 63, for example. After hearing about the situation from the customer and seeing no problem such as an incorrect input of data related to a purchased merchandise item due to the customer's operation error, for example, the attendant adds or cancels the purchased merchandise item that caused the weight abnormality.

Adding a purchased merchandise item determined to be the cause of weight abnormality happens when the customer forgot to operate the camera of the shopping support terminal 1 to read the barcode attached to a purchased merchandise item and put the purchased merchandise item in a shopping basket or the like, for example. In such a case, since the purchased merchandise item is not displayed in the details section 401, the attendant operates the scanner 47 of the payment machine 4 to read the barcode attached to the purchased merchandise item. If the purchase merchandise does not have a barcode, the attendant touches the “No Barcode” button 403. That is, as the registration operation, the attendant operates the scanner 47 to read the barcode attached to the purchased merchandise item, or touches the “No Barcode” button 403 and selects and adds the purchased merchandise item from the list of no barcode merchandise items.

Cancelling a purchased merchandise item determined to be the cause of weight abnormality happens when the customer returned the merchandise item to the display shelf without cancelling the registration of the merchandise item on the shopping support terminal 1, for example. In such a case, the merchandise sales data is displayed as the purchased merchandise item in the details section 401, but that merchandise item is not included in the shopping basket or the like, and accordingly, the attendant touches the “Cancel” button 4011 corresponding to the merchandise item.

Further, the attendant may touch the “Batch Cancellation” button 404 to cancel the registration of all purchased merchandise items, if it is difficult to visually compare the purchased merchandise items with the merchandise sales data due to a large number of the purchased merchandise items, for example. In such a case, for example, in the payment machine 4 installed at the service counter, the attendant re-inputs the data related to the purchased merchandise items from the beginning. The service counter is a place where the attendant is. That is, as the registration cancellation operation, the attendant touches the “Cancel” button 4011 or the “Batch Cancellation” button 404 to cancel the purchased merchandise items.

The processor 41 checks whether the registration operation for a purchased merchandise item is performed, at ACT 35. If the registration operation of a purchased merchandise item is not performed, the processor 41 determines NO at ACT 35 and proceeds to ACT 36. The processor 41 checks whether the registration cancellation operation for a purchased merchandise item is performed, at ACT 36. If the registration cancellation operation for a purchased merchandise item is not performed, the processor 41 determines NO at ACT 36 and returns to the standby state of ACT 35 to ACT 36.

If the registration operation for a purchased merchandise item is performed in the standby state of ACT 35 to ACT 36, the processor 41 determines YES at ACT 35 and proceeds to ACT 37. If the registration operation for a purchased merchandise item is performed, the processor 41 determines that merchandise registration is instructed. That is, the processor 41 determines to register merchandise sales data of a new merchandise item by the function of the determination unit 415.

The processor 41 executes additional processing at ACT 37. Specifically, the processor 41 adds the merchandise sales data of the purchased merchandise item registered by the registration operation to the transaction file.

The processor 41 checks whether the payment button 405 is touched, at ACT 38. If the payment button 405 is touched, the processor 41 determines YES at ACT 38, and proceeds to ACT 21 in FIG. 6. Then, the processor 41 executes the processes of ACT 21 to ACT 25 in the same manner as described above.

If the registration cancellation operation for a purchased merchandise item is performed in the standby state of ACT 35 and ACT 36, the processor 41 determines YES at ACT 36 and proceeds to ACT 39. If the registration cancellation operation for a purchase merchandise is performed, the processor 41 determines that the registration cancellation for a purchased merchandise item is instructed. That is, the processor 41 determines to cancel the registration of the merchandise sales data of the purchased merchandise item by the function of the determination unit 415.

The processor 41 executes the cancellation process, at ACT 39. Specifically, if the cancellation button 4011 is touched, the processor 41 cancels the merchandise sales data of the purchased merchandise item corresponding to the “Cancel” button 4011 from the transaction file. If the “Batch Cancellation” button 404 is touched, the processor 41 collectively cancels the merchandise sales data registered in the transaction file.

At ACT 40, the processor 41 checks whether the cancellation process executed in the process of ACT 39 is the cancellation process due to the “Batch Cancellation” button 404 being touched. If the cancellation process is not due to the “Batch Cancellation” button 404 being touched, that is, if the cancellation process is due to the “Cancel” button 4011 being touched, the processor 41 determines NO at ACT 40 and proceeds to ACT 38. Then, the processor 41 executes the processes of ACT 38 and ACT 21 to ACT 25 of FIG. 6 in the same manner as described above.

If the cancellation process executed in the process of ACT 39 is the cancellation process due to the “Batch Cancellation” button 404 being touched, the processor 41 determines YES at ACT 40 and ends the information processing of the procedure illustrated in FIGS. 5 to 7.

As described in detail above, if a payment barcode is read by the scanner 47, the processor 41 of the payment machine 4 acquires the transaction file associated with the payment barcode from the virtual POS server 3. If the difference between the total of the expected weights of the purchased merchandise items or the weight obtained by adding the weight of the shopping basket to the total of the expected weights, and the total weight of the purchased merchandise items placed on the placement surface 63, which is output by the scale unit 60 exceeds the threshold, an abnormality is detected. Therefore, it is possible to prevent the customer from leaving the store with an unregistered merchandise item.

If the abnormality is detected, the processor 41 issues an abnormality command to the attendant terminal 6. As a result, the abnormality occurrence screen is displayed on the touch panel of the attendant terminal 6. Therefore, the attendant can easily notice the occurrence of the weight abnormality.

In addition, if the abnormality is detected, the attendant operates the scanner 47 to read the code symbol of the attendant ID to operate the payment machine 4 in the attendant mode. Then, the processor 41 determines whether to cancel the merchandise sales data of a purchased merchandise item registered in the transaction file or to register the merchandise sales data of a new merchandise item. Therefore, the attendant can appropriately deal with the weight abnormality depending on the situation of the customer.

Although one or more embodiments of the checkout device and the control method thereof are described above, the embodiments are not limited thereto.

In the embodiments described above, a customer places a smartphone in a shopping cart as the shopping support terminal 1 or carries the smartphone in the store. For example, a tablet terminal attached to a shopping cart (so-called cart terminal) may be used as the shopping support terminal 1.

In the embodiments described above, a payment barcode is obtained by encoding the terminal ID information of the shopping support terminal 1 according to a predetermined barcode system. The payment barcode is not limited to this. For example, the payment barcode may be any code that can identify a transaction file managed by the virtual POS server 3.

In the embodiments described above, if the payment barcode is read by the scanner 47, the payment machine 4 acquires the transaction file associated with the payment barcode from the virtual POS server 3. The method of acquiring the transaction file is not limited to the above. For example, a payment machine code formed of a barcode or a two-dimensional code is prepared in the vicinity of the payment machine 4. The payment machine code is obtained by encoding the payment machine ID set in the payment machine 4. After finishing shopping and moving to the front of the payment machine 4, the customer controls the camera of the shopping support terminal 1 to read the payment machine code. Then, the barcode and the payment machine code are transmitted from the shopping support terminal 1 to the virtual POS server 3. The virtual POS server 3 transmits the transaction file associated with the barcode to the payment machine 4 specified by the payment machine code.

In the embodiments described above, when acquiring the transaction file, the processor 41 at ACT5 calculates the total of the expected weights for each item of merchandise registered in the transaction file. For example, if the processor 41 requests the virtual POS server 3 to transmit a transaction file at ACT 3, the virtual POS server 3 may calculate the total of the expected weights for the items of merchandise registered in the transaction file. Then, the virtual POS server 3 may transmit the transaction file including the total of the expected weights to the payment machine 4.

In the embodiments described above, the processor 41 controls the touch panel 51 to display the calling screen 300. For example, the fact that a weight abnormality is occurred and that an attendant is being called may be output by voice.

In the embodiments described above, the attendant terminal 6 displays the abnormality occurrence screen on the touch panel. For example, the fact that a weight abnormality is occurred in the payment machine 4 identified by the payment machine ID may be output by voice.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout device for a point of sales (POS) system, the device comprising:
a table on which one or more merchandise items can be placed;
a scale configured to measure a total weight of the merchandise items placed on the table;
a scanner configured to read an image displayed on a terminal operated by a customer; and
a processor configured to:
upon receipt of the image by the scanner, determine one or more merchandise items that have been registered by the customer using the terminal,
determine a total weight of the registered merchandise items using a weight predetermined for each merchandise item,
determine whether a difference between the determined total weight and the measured total weight exceeds a threshold, and
upon determining that the difference exceeds the threshold, issue an abnormal command.

2. The checkout device according to claim 1, further comprising:
a communication interface circuit configured to communicate with an attendant terminal, wherein
the processor is further configured to control the communication interface circuit to transmit the abnormal command to the attendant terminal.

3. The checkout device according to claim 2, wherein the abnormal command causes the attendant terminal to display a screen indicating that an abnormal event has occurred.

4. The checkout device according to claim 1, wherein
the image includes a symbol that identifies the terminal, and
the processor is further configured to acquire, using the symbol read by the scanner, sales transaction data indicating the merchandise items registered using the terminal.

5. The checkout device according to claim 4, wherein the symbol is a barcode.

6. The checkout device according to claim 4, wherein the processor is further configured to, after issuing the abnormal command, determine whether to add or remove data of a merchandise item to or from the acquired sales transaction data.

7. The checkout device according to claim 1, further comprising:
a display, wherein
the processor is further configured to, after issuing the abnormal command, control the display to display a message indicating that a weight abnormality is detected.

8. The checkout device according to claim 7, wherein the processor is further configured to control the display to display a screen through which whether a shopping basket is placed on the table can be selected.

9. The checkout device according to claim 8, wherein the processor is further configured to, upon receipt of a selection indicating that the shopping basket is placed on the table, add a predetermined weight of the shopping basket to the determined total weight.

10. The checkout device according to claim 7, wherein the processor is further configured to, upon determining that the difference does not exceed the threshold, control the display to display a screen through which a payment method can be selected.

11. A method performed by a checkout device for a point of sales (POS) system, the method comprising:
reading an image displayed on a terminal operated by a customer;
determining one or more merchandise items that have been registered by the customer using the terminal;
determining a total weight of the registered merchandise items using a weight predetermined for each merchandise item;
measuring a total weight of one or more merchandise items placed on a table;
determining whether a difference between the determined total weight and the measured total weight exceeds a threshold; and
after determining that the difference exceeds the threshold, issuing an abnormal command.

12. The method according to claim 11, further comprising:
transmitting the abnormal command to an attendant terminal.

13. The method according to claim 12, wherein the abnormal command causes the attendant terminal to display a screen indicating that an abnormal event has occurred.

14. The method according to claim 11, wherein
the image includes a symbol that identifies the terminal, and the method further comprising:
acquiring, using the symbol, sales transaction data indicating the merchandise items registered using the terminal.

15. The method according to claim 14, wherein the symbol is a barcode.

16. The method according to claim 14, further comprising:
after the abnormal command is issued, determining whether to add or remove data of a merchandise item to or from the acquired sales transaction data.

17. The method according to claim 11, further comprising:
after the abnormal command is issued, displaying a message indicating that a weight abnormality is detected.

18. The method according to claim 11, further comprising:
displaying a screen through which whether a shopping basket is placed on the table can be selected.

19. The method according to claim 18, further comprising:
after receiving a selection indicating that the shopping basket is placed on the table, adding a predetermined weight of the shopping basket to the determined total weight.

20. A point of sales (POS) system, comprising:
a terminal operated by a customer in a store and including a display configured to display an image that identifies the terminal; and
a checkout device installed in the store and including:
a table on which one or more merchandise items can be placed,
a scale configured to measure a total weight of the merchandise items placed on the table,
a scanner configured to read the image displayed on the terminal, and
a processor configured to:
upon receipt of the image by the scanner, determine one or more merchandise items that have been registered by the customer using the terminal,
determine a total weight of the registered merchandise items using a weight predetermined for each merchandise item,
determine whether a difference between the determined total weight and the measured total weight exceeds a threshold, and
upon determining that the difference exceeds the threshold, issue an abnormal command.
